(19) United States
(12) Patent Application Publication
(10) Pub. No.: US 2010/0002272 A1
(43) Pub. Date: Jan. 7, 2010

(54) IMAGE PROCESSING DEVICE AND IMAGE PROCESSING METHOD

(75) Inventors: Mineko Sato, Yokohama-shi (JP); Shinichi Fukada, Kawasaki-shi (JP); Kunio Yoshihara, Hachioji-shi (JP); Hiroyuki Kimura, Kawasaki-shi (JP); Tsutomu Murayama, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/490,951

(22) Filed: Jun. 24, 2009

(30) Foreign Application Priority Data
Jul. 3, 2008 (JP) 2008-174713

(51) Int. Cl. H04N 1/38

(52) U.S. Cl. 358/464

(57) ABSTRACT

An object of the present invention is to improve an image quality of a regeneration image of the identified ink jet document. The present invention includes a paper fiber detecting unit configured to detect a paper fiber for each pixel by an image signal obtained by reading a document, a print pixel identifying unit configured to identify whether or not pixels are print pixels for each pixel by the image signal, a document pixel identifying unit configured to identify whether or not the pixel is a pixel requiring a correction based upon the detection result by the paper fiber detecting unit and the identification result by the print pixel identifying unit, and an image correcting unit configured to correct the image signal in a case where it is determined that the pixel is the document pixel requiring the correction by the document pixel identifying unit.

### BACKGROUND OF THE INVENTION

1. Field of the Invention

The present invention relates to a method which can identify a document outputted as an image by an ink jet printing method of an ink jet printer or the like, based upon an image data obtained by reading the document, and an image processing device and a program relating to the method.

2. Description of the Related Art

At present, there is known an image processing device called a so-called MFP (Multi Function Printer) constituted as a complex machine of image processing devices each having a different function, such as a copier, a facsimile machine and a scanner. In MFP equipped with these copying functions, various modes such as an ink jet mode, a pencil mode and a fluorescent pen mode are in advance prepared. This MFP provides the function for making a correction to a regeneration image in accordance with a characteristic of each document by the various modes. For example, in a case where a document is printed by an ink jet printing method of ink jet or the like, the density degrades generally as compared to a printed matter such as a document printed by a laser beam printer. Therefore, a correction for compensating for the degraded density is made in the ink jet mode. When an operator selects a mode from these modes in accordance with the characteristic of the document, correction processing of an image is executed in consideration of the printing characteristic in accordance with the kind of the document, such as a document printed by an ink jet printing method or a document including a description by a fluorescent pen, making it possible to produce an image in a high grade.

On the other hand, the following technology is known as a method of identifying whether or not a document is printed by an ink jet printing method, by reading the document and processing the read image signal.

Japanese Patent Laid-Open No. 2006-115425 and Japanese Patent Laid-Open No. H10-126631(1998) each describe a technology in which feature amounts of plural kinds such as a color reproduction region and a texture are extracted from the read image data, and it is identified whether or not the read document is a document printed by an ink jet printing method, based upon the obtained feature amounts.

In addition, Japanese Patent Laid-Open No. 2004-320160 describes a technology in which it is identified whether or not the document is a document printed by an ink jet printing method, based upon detection and analysis of a background region on which the document is not printed, that is, a paper itself.

Further, Japanese Patent Laid-Open No. 2005-142740 describes a technology in which a histogram showing a relation between a dark/light value showing dark/light of pixels and the number of the pixels is produced based upon an image data obtained by reading a document and it is identified whether or not the read document is a document printed by an ink jet printing method, based upon a feature amount in a region of the dark/light value obtained from the histogram.

However, these technologies have the following problems.

Using the method in which, the feature amount in regard to the color reproduction region or the texture is, as described in Japanese Patent Laid-Open No. 2006-115425 or Japanese Patent Laid-Open No. H10-126631(1998), is extracted and the document is identified based upon the extracted feature amount, it has been almost impossible to read the texture by an error diffusion method because of a recent improvement in printing density of an ink jet printer. Further, since the feature amount regarding the color reproduction region largely changes depending on the kind of a paper in use, it is becoming hard to identify the document.

In addition, in the method of identifying a document by detecting and analyzing the paper itself as described in Japanese Patent Laid-Open No. 2004-320160, it is difficult to identify a so-called plain paper used commonly in various types of printing.

Further, in the method of determining a document by a histogram showing a relation between a dark/light value showing dark/light of pixels and the number of the pixels as described in Japanese Patent l,aid-Open No. 2005-142740, the identification accuracy is low since the histogram depends greatly on the content of the document itself. In addition, since the determination by the color reproduction region or the density histogram is made over the entire page as a determination object, it is hard to make a micro determination such as a determination on a specific portion in the page and the image processing can not be executed at a mode adapted for the micro determination.

The present invention is made in view of the foregoing problems, and an object of the present invention is to provide an image processing method which accurately identifies a document in which characters or images are drawn particularly on a plain paper by ink droplets of an ink jet printing method or a fluorescent pen (hereinafter, referred to as “ink jet document”) and also improves an image quality of a regeneration image of the identified ink jet document, and is to provide an image processing device relating to this image processing method.

### SUMMARY OF THE INVENTION

The present invention comprises the following elements for solving the above problems.

An image processing device according to the present invention comprises a paper fiber detecting unit configured to detect a paper fiber for each pixel by an image signal obtained by reading a document, a print pixel identifying unit configured to identify whether or not pixels are print pixels for each pixel by the image signal, a document pixel identifying unit configured to identify whether or not the pixel is a pixel requiring a correction based upon the detection result by the paper fiber detecting unit and the identification result by the print pixel identifying unit, and an image correcting unit configured to correct the image signal in a case where it is determined that the pixel is the document pixel requiring the correction by the document pixel identifying unit.

In addition, an image processing device according to the present invention comprises a paper fiber detecting unit configured to detect a paper fiber for each pixel by an image signal obtained by reading a document, a print pixel identifying unit configured to identify whether or not pixels are print pixels for each pixel by the image signal, a document pixel identifying unit configured to identify whether or not the pixel is a pixel requiring a correction based upon the detection result by the paper fiber detecting unit and the identification result by the print pixel identifying unit, a document identifying unit configured to, after the identifications on all the pixels in the document by the document pixel identifying unit are completed, determine whether or not the document is a document requiring a correction, for each page based upon the identification result, and an image correcting unit configured to correct the image signal in a case where it is determined that the document is the document requiring the correction by the document identifying unit.

In addition, an image processing method according to the present invention comprises a step of detecting a paper fiber for each pixel by an image signal obtained by reading a document, a step of identifying whether or not pixels are print pixels for each pixel by the image signal, a step of identifying whether or not the pixel is a pixel requiring a correction based upon the detection result by the paper fiber detecting step and the identification result by the print pixel identifying step, and a step of correcting the image signal in a case where it is determined that the pixel is the document pixel requiring the correction by the step of identifying whether or not the pixel is the pixel requiring the correction.

Further, an image processing method according to the present invention comprises a step of detecting a paper fiber for each pixel by an image signal obtained by reading a document, a step of identifying whether or not pixels are print pixels for each pixel by the image signal, a step of identifying whether or not the pixel is a pixel requiring a correction based upon the detection result by the paper fiber detecting step and the identification result by the print pixel identifying step, a step of, after the identifications on all the pixels in the document by the step of identifying whether or not the pixel is the pixel requiring the correction are completed, determining whether or not the document is a document requiring a correction, for each page based upon the identification result, and a step of correcting the image signal in a case where it is determined that the document is the document requiring the correction by the step of identifying whether or not the document is the document requiring the correction.

Further, an image processing program according to the present invention performs the above method by a computer.

A computer readable printing medium according to the present invention prints a program for performing the above method by a computer.

The present invention uses a behavior that ink droplets by an ink jet printing method or a fluorescent pen spread into an inside of a fiber in a paper. By detecting an existence of a paper fiber in a print pixel portion extracted from an input image data obtained by reading a document, an ink jet document can be determined in a high accuracy and without an influence of another factor.

In regard to the document requiring a correction, which is determined as the ink jet document, bleeding and degradation of brightness/density which are generated by penetrating of the ink droplet into the inside of the paper fiber are corrected, therefore making it possible to correct the document to produce an image in a higher grade.

Further, since also apart in a page which is touched up by a fluorescent pen can be identified, the image processing the most suitable in accordance with a partial characteristic of the document can be executed, therefore making it possible to correct the document to produce an image in a higher grade.

Further features of the present invention will become apparent from the following description of exemplary embodiments (with reference to the attached drawings).

### BRIEF DESCRIPTION OF THE DRAWINGS

FIG. 1 is a flow chart showing the processing of an IJ document identifying/image correcting unit 210 according to a first embodiment;

FIG. 2 is a schematic construction block diagram of the present invention;

FIG. 3A is diagram explaining a difference in attachment of a print material to a paper by a printing method;

FIG. 3B is diagram explaining a difference in attachment of a print material to a paper by a printing method;

FIG. 4 is a diagram explaining the reading of an image;

FIG. 5A is diagram explaining a difference in a situation of reading a paper fiber between a case of ink jet printing and a case of electronic photo printing;

FIG. 5B is diagram explaining a difference in a situation of reading a paper fiber between a case of ink jet printing and a case of electronic photo printing;

FIG. 6 is a diagram showing an example of a weight coefficient used upon finding an average value;

FIG. 7A is diagram showing an example of the paper fiber detecting result of each of the ink jet document and the electronic photo document;

FIG. 7B is diagram showing an example of the paper fiber detecting result of each of the ink jet document and the electronic photo document;

FIG. 8A is diagram showing a correction example of fiber determination FJ;

FIG. 8B is diagram showing a correction example of fiber determination FJ;

FIG. 9A is diagram showing an example of the print pixel identification result of each of the ink jet document and the electronic photo document;

FIG. 9B is diagram showing an example of the print pixel identification result of each of the ink jet document and the electronic photo document;

FIG. 10A is diagram showing a correction example of the print pixel identification result;

FIG. 10B is diagram showing a correction example of the print pixel identification result;

FIG. 11A is explanatory diagram showing an IJ document identification by referring to neighboring pixels.

FIG. 11B is explanatory diagram showing an IJ document identification by referring to neighboring pixels.

FIG. 12 is a diagram showing an example of a screen on which an operator sets an image correction amount;

FIG. 13 is a flow chart showing the processing of an IJ document identifying/image correcting unit 210 according to a second embodiment; and

FIG. 14 is a block diagram of an IJ document identifying/image correcting unit 210 by a hard circuit according to a third embodiment.

### DESCRIPTION OF THE EMBODIMENTS

Embodiments of carrying out the present invention will be hereinafter explained with reference to the drawings.

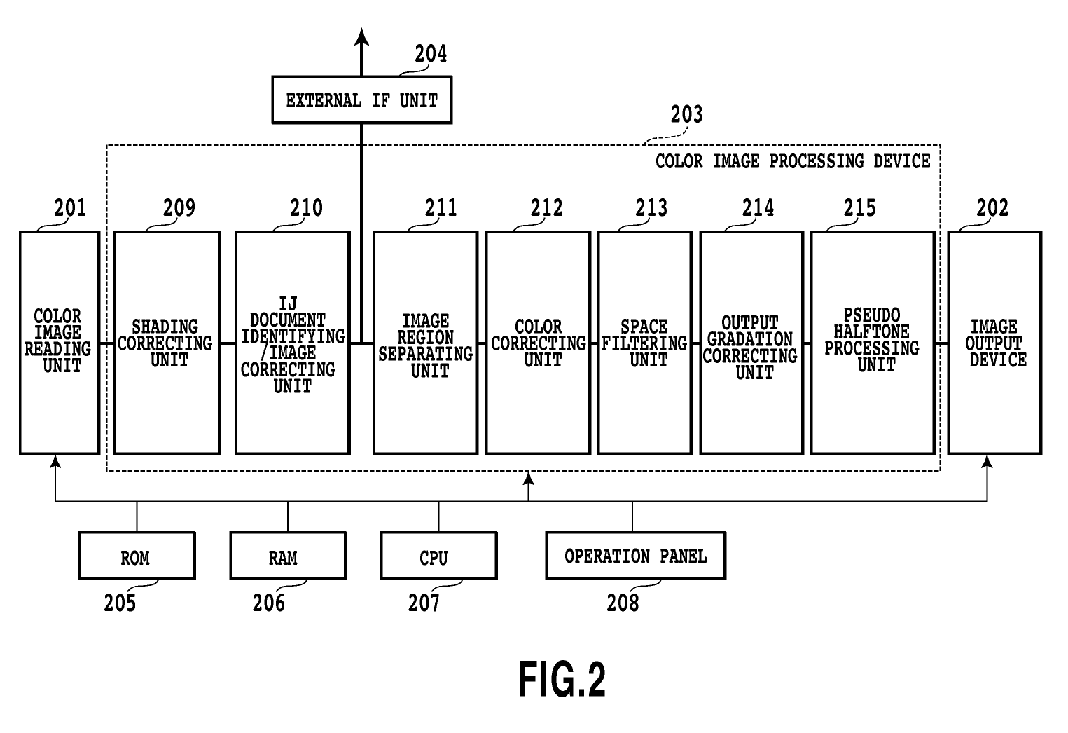

FIG. 2 is a block diagram showing a schematic construction of a digital color copying machine to which an image processing device according to the present invention is applied.

The digital color copying machine according to the present embodiment is provided with a color image reading unit 201, a color image processing device 203, and an image output device 202. An operation panel 208, a ROM (Read Only Memory) 205, a RAM (Random Access Memory) 206, and a CPU (Central Processing Unit) 207 are connected to the digital color copying machine. The color image processing device 203 is configured of a shading correcting unit 209, an ink jet (IJ) document identifying/image correcting unit 210, an image region separating unit 211, a color correcting unit 212, a space filtering unit 213, an output gradation correcting unit 214, and a pseudo halftone processing unit 215.

An outline of the digital color copying machine according to the present embodiment is as follows.

The color image reading unit 201 is configured of a scanner unit (not shown) equipped with, for example, a CCD (Charge Couple Device). The color image reading unit 201 reads a reflective image from a document by the CCD as an analog signal of R/G/B (R: red, G: green and B: blue) and outputs the analog signal to the color image processing device 203.

The analog signal read at the color image reading unit 201 is converted into a digital signal (not shown). The converted digital signal is transmitted in the order of the shading correcting unit 209, the IJ document identifying/image correcting unit 210, the image region separating unit 211, the color correcting unit 212, the space filtering unit 213, the output gradation correcting unit 214, and the pseudo halftone processing unit 215. Then, the digital signal is outputted as a digital camera signal expressing C/M/Y/K (C: cyan, M: magenta, Y: yellow, and K: black) to the image output device 202. On the other hand, the image signal corrected in image at the IJ document identifying/image correcting unit 211 is previewed on the operation panel 208. Further, the image signal is outputted through an external interface (IF) unit 204 to an external information processing device (not shown) according to a program stored in the ROM 205.

Next, the respective units constituting the color image processing device 203 of the digital color copying machine according to the present embodiment will be explained.

The shading correcting unit 209 executes the correction processing by which various distortions generated in an illumination system, an imaging system, and an image pick up system in the color image reading unit 201 are removed so that the entire image has uniform brightness on an average. In the shading correcting unit 209, adjustment of the color balance is also made. That is, the shading correcting unit 209 generates R/G/B signals (reflectance signals of R/G/B) in which the various distortions are removed and the adjustment of the color balance is made.

In the IJ document identifying/image correcting unit 210, the R/G/B signal generated in the shading correcting unit 209 is converted into a signal such as a brightness signal which can be easily handled in the image processing system adopted in the color image processing device 203. Along with it, it is determined whether or not the document is the ink jet document requiring a correction. When the document corresponding to the image signal is determined as the ink jet document, the bleeding or the reduction of the brightness in regard to the image (R/G/B) signal corrected in the shading correcting unit 209 is corrected. A detail of the processing executed by the IJ document identifying/image correcting unit 210 will be described later.

In the image region separating unit 211, the respective pixels in the input image are separated into either of a character region, a dot region, and a photo region based upon the R/G/B signal. A region identification signal showing to which region the pixel belongs is generated based upon the separated result, and the region identification signal of the pixel is outputted to the color correcting unit 212, the space filtering unit 213 and the pseudo halftone processing unit 215. The input signal outputted from the IJ document identifying/image correcting unit 210 is outputted to the subsequent color correcting unit 212 as it is.

In the color correcting unit 212, a C/M/Y/K signal is generated from the R/G/B signal. For accurately realizing color reproduction by toner of four colors of C, M, Y and K, there is executed the processing of removing color turbidity based upon spectral characteristics of C, M and Y color materials, including unnecessary absorption components.

The space filtering unit 213 executes the space filter processing by a digital filter to the image data expressed by the C/M/Y/K signal inputted from the color correcting unit 212, based upon the region identification signal generated in the image region separating unit 211. This space filter processing prevents blur or grainy degradation of the output image by correcting a space frequency characteristic.

In addition, the pseudo halftone processing unit 215 executes the processing of reproducing a halftone image in a pseudo way to the image data expressed by the C/M/Y/K signal, based upon the image region identification signal.

For example, in the region separated into the character region in the above image region separating unit 211, particularly for enhancing the reproduction performance of a black character or a colored character, an emphasis amount of the high frequency is increased in sharpness emphasis processing in the space filter processing by the space filtering unit 213. At the same time, in the pseudo halftone processing unit 215, binarization or multi.-value processing in a screen with high resolution suitable for reproduction of the high region frequency is selected. In regard to the region separated into the dot region in the image region separating unit 211, the space filtering unit 213 executes low-pass filter processing for removing input dot components. The output gradation correcting unit 214 executes output gradation correction processing which converts a signal such as a density signal into a dot area rate as a characteristic value of the image output device 202. After the output gradation correction processing is completed, the pseudo halftone processing unit 215 executes the pseudo halftone processing in which the image is finally separated into the pixels to reproduce the gradation of each.

Further, in regard to the region separated into the photo region in the image region separating unit 211, the binarization or the multi-value processing is executed in the screen in which importance is placed on the gradation reproduction performance.

Next, the operation panel 208 is configured of, for example, a display unit such as a liquid crystal display (not shown), a setting button, a touch panel sensor and the like. Operations of the color image reading unit 201, the color image processing unit 203 and the image output device 202 are controlled based upon the information inputted from the operation panel 208.

The image data to which each of the aforementioned processing is executed is stored in the RAM 206 once and is read out at a predetermined timing to be inputted to the image output device 202. This image output device 202 outputs the image data on a printing medium (for example, a paper or the like). Examples of the image output device 202 include a color image output device using an electronic photo method or an ink jet printing method, but are not limited thereto particularly.

It should be noted that above processing is controlled by the CPU 207. The schematic construction block diagram shown in FIG. 2 is an example of a color system, but the present invention is carried out also in a monochrome system. In a case of the monochrome system, the color image reading unit 201 serves as a monochrome image reading unit and the color correcting unit becomes unnecessary. Particularly the correction of the image signal in the IJ document identifying/image correcting unit 210 is made to the density reduction in the brightness signal and the bleeding.

<Principle for Identifying an Ink Jet Document>

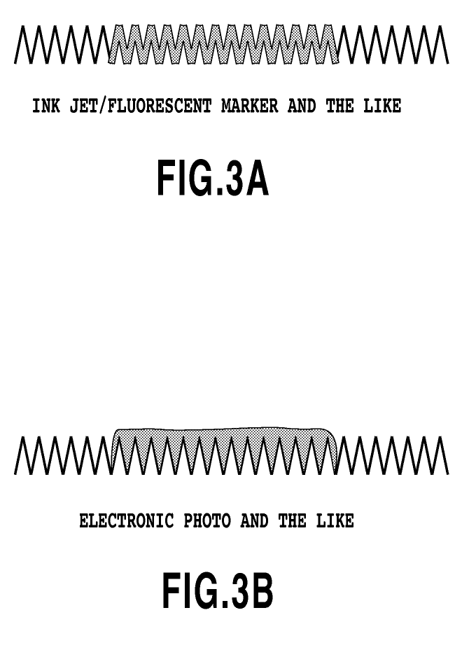

Before explaining a detail of each embodiment in the present invention, a principle for identifying an ink jet document requiring a correction will be explained with reference to FIGS. 3A and FIG. 3B.

FIG. 3A shows a state where inkdroplets are dropped on a sheet surface of a plain paper by an ink jet printing method. For comparison, FIG. 3B shows where toner is molten by an electronic photo printing method.

In a case of the ink jet printing method, since ink droplets having several p1 (pico litters) as the minimum unit are ejected from narrow nozzles, the viscosity is low. Therefore, the ink droplet spreads into a gap between fibers of a paper tangled complicatedly, each having from several μm to several 100 μm. The spread of the ink droplet creates bleeding at an edge portion of the image to prevent the expression in a high density. As a result, the color saturation is degraded and the color image can not obtain the color saturation which is desired to be primarily expressed. Therefore, the correction for compensating for the color saturation by the degraded amount is required.

Also in a case of description by a fluorescent pen, the fluorescent ink droplets spread into a gap between fibers of a paper. Since in this type of device in itself, the fluorescent color can not be read by the color saturation which is visible by persons, it is necessary to make the correction emphasizing the color saturation in the same way as the document by the ink jet printing method.

On the other hand, in an electronic photo printing method where solid toner is molted by heat and pressurized to fix an image on a paper, the toner is fixed as a solid on the fibers of the paper. Therefore, the toner does not spread into the gap between the fibers of the paper to produce the bleeding at the edge of the image, and the color saturation correction is not necessary.

Therefore, the printed pixel is read, and a diffuse reflective image by paper fibers is examined from the image signal. When the diffuse reflective image is detected, it is determined that the document is the document by the ink jet printing method requiring the correction. In consequence, it is possible to distinguish the ink jet document requiring the correction from the document not requiring the correction (document by an electronic photo printing method or document printed on an) and it is possible to make a correction only to the document requiring the correction.

It should be noted that, for expressing a document in a high density also in the ink jet printing method, there is a case of using a special paper with a coating layer absorbing ink droplets on a surface of the paper. In a case of a document which is thus printed on the special paper by the ink jet printing method, a diffuse reflective image by the fiber of the paper can not detected. However, since in this case, both the bleeding and degradation of the color saturation do not occur, it is not required to correct the image signal. Therefore, in a case of the special paper, even if the document can not be determined as the ink jet document, any problem does not occur.

In addition, the ink used in a general offset print has high viscosity and therefore, does not spread into a gap between fibers of a plain paper. Therefore, the fiber of the paper is not detected and as a result, is determined that the document is not the ink jet document, but the problem with the color saturation degradation by the bleeding does not occur originally in the same way as in a case of the electronic photo printing method.

Hereinafter, a detail of the processing executed by the IJ document identifying/image correcting unit 210 will be explained.

### First Embodiment

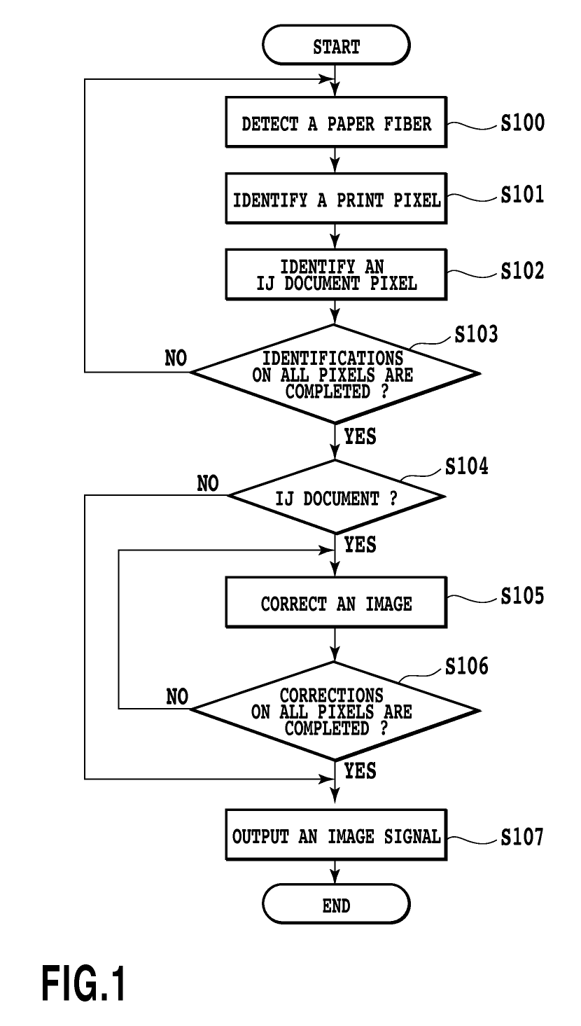

A detail of the processing executed by the IJ document identifying/image correcting unit 210 will be explained according to the process flow shown in FIG. 1. In the present embodiment, the IJ document identifying/image correcting unit 210 is carried out according to a program stored in the ROM 205 by the CPU 207, thereby executing the identification processing of the ink jet document and the correction processing of the image.

First, S100 is the process for detecting fibers of a paper. Here, the detection process is executed based upon an image signal in which colors of R, G and B to which the shading correction is made are separated.

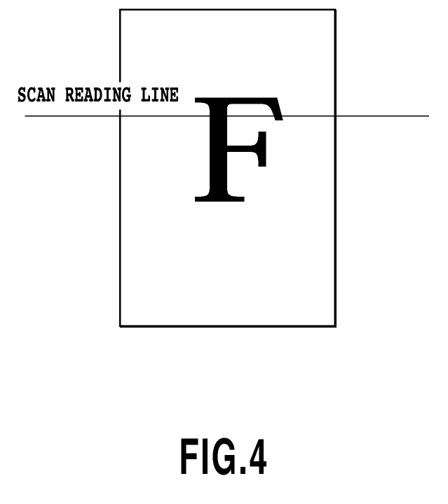

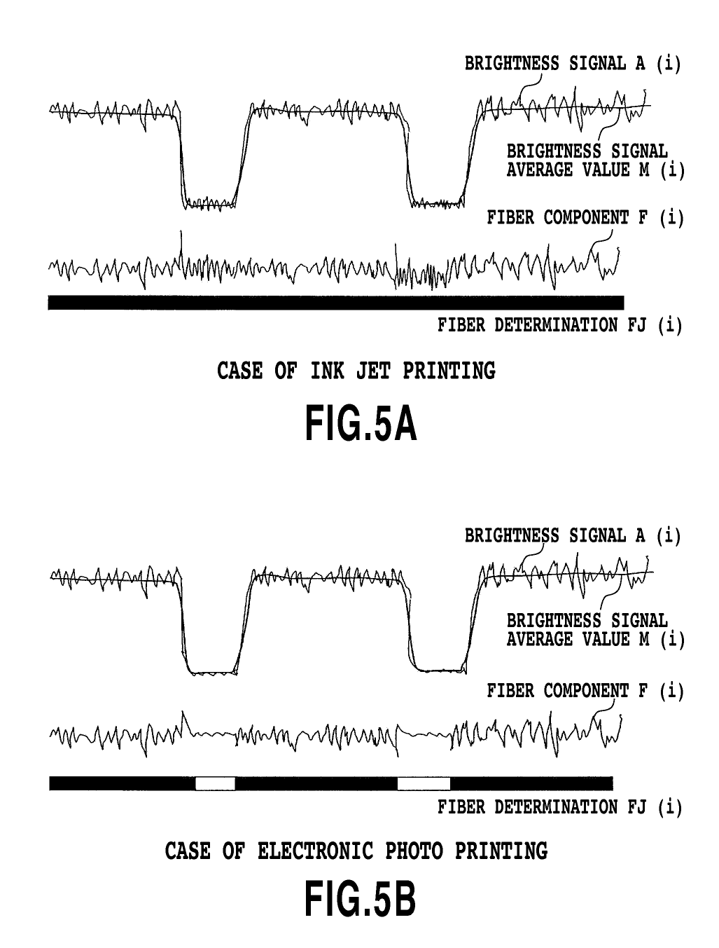

FIG. 4 shows a state of reading a document where an alphabet “F” is printed, by a portion of one line at the color image reading unit 201. FIGS. 5A and 5B are diagrams each showing a relation between brightness signal A(i), average value M (i) of the brightness signal, fiber component F(i) and fiber determination FJ(i) in a case where the document is printed by an ink jet printing method and in a case where the document is printed by an electronic photo printing method.

The brightness signal A(i), in a case where the document is separated into three colors of R, G, and B to be read, generally has a relation of “A (i)=(a*R(i)+b*G(i)+c*B (i))/(a+b+c)”. Herein, a+b+c=1, and a, b, and c are constants.

In the present embodiment, for simplification of the calculation, the brightness signal A(i) is designed to have a relation of “A(i)=(R(i)+2*G(i)+B(i))/4”. The average value M(i) of the brightness signal is, as shown in Expression (1), a weighted average value using a brightness signal A(i) of a pixel near an attention pixel position.

M(i)=ΣΣR×A(i) Expression (1)

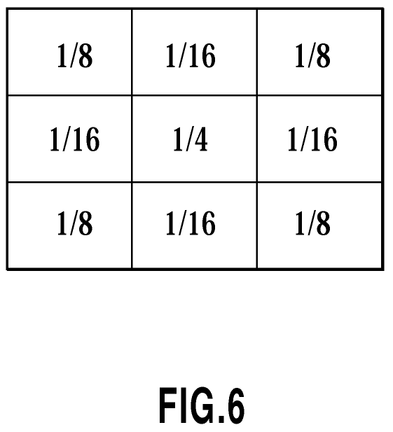

Therein, R is a weight coefficient to each pixel at the neighboring positions, for example, a value shown in FIG. 6. In the present embodiment, R is an average value of 8 pixels in the periphery of the attention pixel.

The fiber component of the paper is usually superimposed on the average value. Therefore, as seen in FIG. 5A and FIG. 5B, by using the previous brightness signal A(i) and the average signal M(i) of the brightness signal, the fiber component F(i) can be extracted by, for example, Expression (2).

F(i)={255/A(i)}×{A(i)−M(i)} Expression (2)

It should be noted that the brightness signal A(i) is a signal of 8 bits and is values from 0 to 255 as a value of the brightest portion. The determination result on presence/absence of a diffuse reflective image of the fiber from the fiber component F(i) obtained in Expression (2) is shown in FJ(i). The determination is made according to the following Expression (3).

When K1<absolute value F (i)<K2, FJ(i)=1, that is, presence of the fiber is determined, and when absolute value F(i)≦K1 or K2≦absolute value F(i), FJ(i)=0, that is, absence of the fiber is determined . . . Expression (3).

That is, since the fiber of the paper is read as a signal value having an amplitude to the extent of not affecting the image, a constant K1 is set to identify a case where toner is attached to the extent that the toner completely covers the fiber structure of the paper by an electronic photo or the like. For avoiding an erroneous determination that a rapid changing point of the image is determined as the presence of the fiber in error or for avoiding an influence of the noise of the brightness signal A(i) itself, a constant K2 is set. In FIG. 5B, it is found out that the fiber of the paper can not be detected in a portion on a scan reading line of alphabet “F” shown in FIG. 4. It should be noted that this determination is made over the entire region of the document every one pixel.

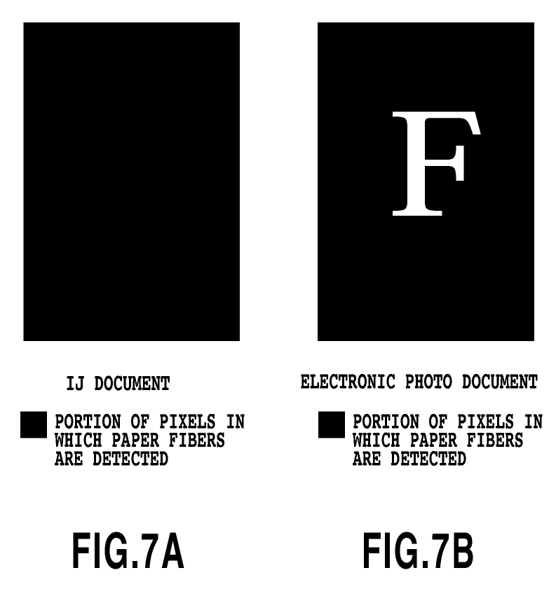

FIGS. 7A and 7B are diagrams showing the detection result of a paper fiber in a case where the documents printed on the same paper by the ink jet printing method and by the electronic photo printing method are read and the above processing is executed to the documents, where a portion painted in black is a pixel in which the presence of the paper fiber is identified.

In FIG. 7A, the entire document is coated in black and the presence of the fiber of the paper can be stably detected also in a portion of the pixel on which alphabet “F” is printed.

On the other hand, in FIG. 7B, alphabet “F” appears as an outlined white character on the black background and the presence of the fiber of the paper can not be detected in the pixel corresponding to the portion of alphabet “F”.

In this way, presence/absence of the diffuse reflective image of the paper fiber is determined and identified.

The previous processing method shows an example of detecting the diffuse reflective image of the paper fiber from the brightness signal A(i). Next, as a different processing method, there is hereinafter shown a method in which the brightness signal A(i) is converted into a density signal D(i) using Expression (4) and thereafter, a fiber component F(i) is found.

D(i)=255−K3×log A(i)+K4 Expression (4)

Herein, K3 and K4 are constants and the density signal ID(i) is values from 0 to 255 as a value of the brightest portion. By using a so-called high pass filter H extracting only two-dimensionally high space frequency components to the density signal D(i), only the fiber component in detail explained previously can be directly extracted.

F(i)=ΣΣD(i)×H Expression (5)

That is, it can be said that this processing is a method based upon recognition that frequency components of an image or frequency components due to the pseudo halftone processing are sufficiently low as compared to those of the fiber component F(i).

It should be noted that the method of detecting the diffuse reflective image of the paper fiber from the obtained fiber component F(i) is the same as Expression (3) shown previously, and therefore, the subsequent explanation is omitted.

Both of the two kinds of the processing determine presence/absence of the diffuse reflective image of the paper fiber for each pixel to generate fiber determination FJ(i). However, the presence/absence of the diffuse reflective image of the paper fiber does not originally differ in each pixel in a region in which micro pixels each having the order of 600 DPI are adjacent to each other. Therefore, a different processing method of correcting the fiber determination FJ(i) is shown.

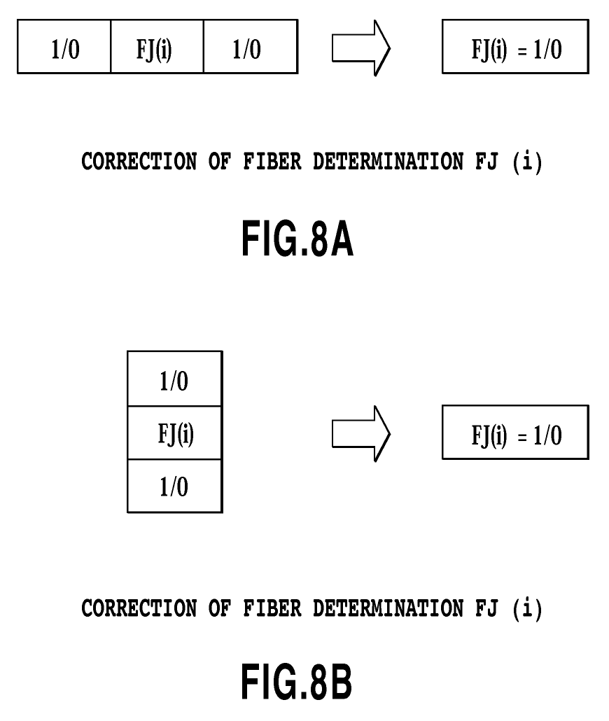

For example, a pattern in which each of the FJ(i) values in neighboring pixels in both sides of the determination object pixel is “1” or “0” as shown in FIG. 8A or a pattern in which each of the FJ(i) values in upward and downward sides of the determination object pixel is “1” or “0” as shown in FIG. 8B is studied. In this case, by referring to each of the FJ(i) values in the neighboring pixels, the fiber determination FJ(i) at the attention pixel position is corrected as shown in the figure. That is, when a value of the neighboring pixel is “1”, the fiber determination FJ(i) at the attention pixel position is corrected as “1”, and when the value of the neighboring pixel is “0”, the fiber determination FJ(i) at the attention pixel position is corrected as “0”.

Based upon this correction, the fiber determination FJ(i) separately generated in each pixel unit by noises or the like can be corrected, obtaining a stable final result in regard to the presence/absence of the diffuse reflective image of the paper fiber.

It should be noted that the processing method shown In FIG. 8A and FIG. 8B are used in a case of correcting the fiber determination FJ(i) in each pixel unit, but the correction by referring to the determination result of the neighboring pixels (or neighboring regions) in each region unit wider than the pixel unit can be also made.

Next, S101 is print pixel identification processing for determining whether or not the pixel is the pixel printed by a print material, for each pixel.

The determination on existence of the print pixel made for each pixel can be easily obtained by the brightness signal A(i) and Expression (6).

In a case where A (i)≦K5, P(i)=1, that is, the pixel is determined as the print pixel.

In a case where A(i)>K5, P(i)=0, that is, it is determined that the pixel is not the print pixel.

### Expression (6)

Here, P(i) means the determination result whether or not a pixel is printed by any printing material. In a case where the brightness signal A(i) is equal to or less than constant K5, P(i) is defined to be equal to 1 to determine that the pixel is a print pixel. However, in a case where the brightness of the printing material is low in some degree, since reflective light by the fiber of a paper is absorbed by the printing material and the fiber component can not be detected accurately, the pixel is excluded from the determination object pixel.

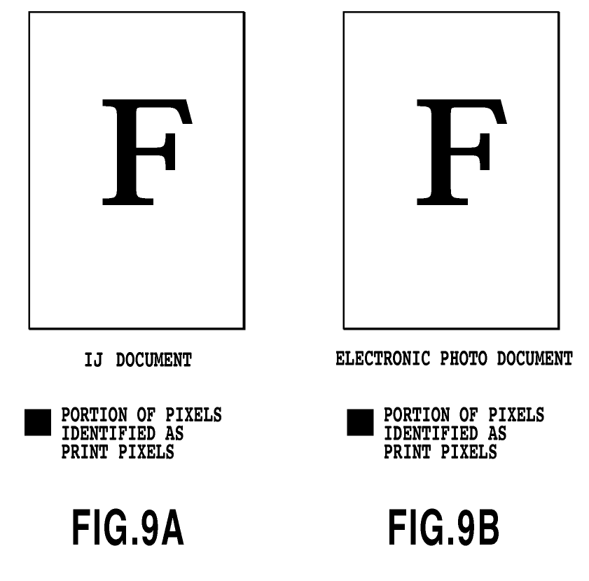

FIGS. 9A and 9B are diagrams in which documents printed respectively by an ink jet printing method and by an electronic photo printing method are read and the result of determination on whether or not the pixel is a print pixel is shown according to Expression (6). A portion coated in black is the pixel determined as the print pixel. In both the documents printed by the ink jet printing method and by the electronic photo method, alphabet “F” appears in an outlined black character on the background, and as a result, the portion is determined as the print pixel.

The aforementioned processing method generates determination P(i) on presence/absence of the print pixel for each pixel. However, the determination result of the print pixel does not originally differ in each pixel in a region in which micro pixels each having the order of 600 DPI are adjacent to each other. Therefore, a different processing method of correcting the determination P(i) in the print pixel is shown.

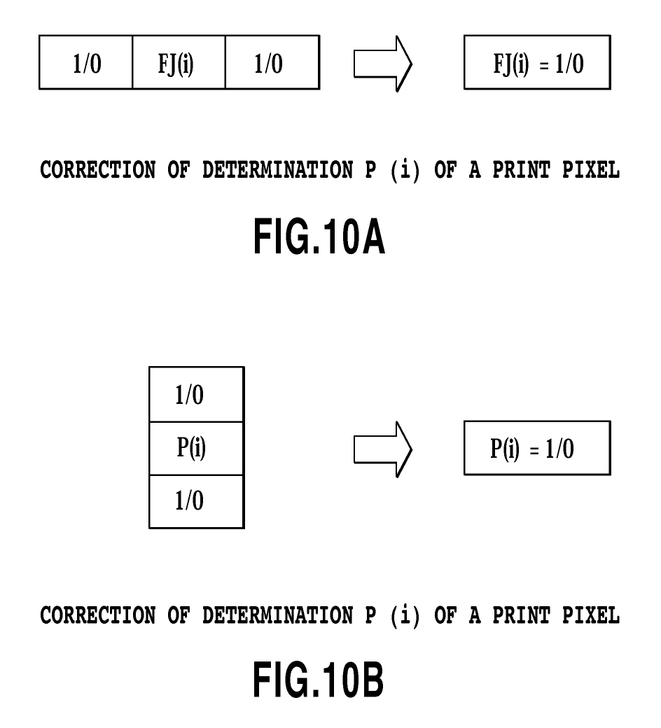

For example, a pattern in which each of the P(i) values in neighboring pixels in both sides of the determination object pixel is “1” or “0” as shown in FIG. 10A or a pattern in which each of the P(i) values in upward and downward sides of the determination object pixel is “1” or “0” as shown in FIG. 10B is studied. In this case, by referring to each of the P(i) values in the neighboring pixels, the determination result P(i) of the print pixel at the attention pixel position is corrected as shown in the figure. That is, when a value of the neighboring pixel is “1”, the determination result P(i) of the print pixel at the attention pixel position is corrected as “1”, and when the value of the neighboring pixel is “0”, the determination result P(i) of the print pixel at the attention pixel position is corrected as “0”.

Based upon this correction, the determination result P(i) separately generated in each pixel unit by noises or the like can be corrected, finally obtaining a stable print pixel identification result.

Shows a case of correcting the determination result P(i) in each pixel unit, but the correction by referring to the determination result of the neighboring pixels (or neighboring regions) in each region unit wider than the pixel unit can be also made.

Next, S102 of IJ document pixel identification will be explained. S102 is the process in which the fiber determination FJ(i) and the print pixel identification result P(i) obtained by the determination for each pixel are used to identify whether or not each pixel is a part of the ink jet document. That is, S102 is the process for identifying whether or not the pixel among pixels constituting the document is a pixel of a portion including an ink component.

The ink jet document determination is made for each pixel according Expression (7) based upon the fiber determination FJ(i) and the print pixel identification result P(i) which are the detection results of the aforementioned paper fiber. That is,

in a case where P(i)=1 and FJ(i)=1, IJ(i)=1, and the pixel is determined as the IJ document pixel, and in a case where either of P(i) and FJ(I) is 0, IJ(i)=0, it is determined that the pixel is not the IJ document pixel.

### Expression (7)

It should be noted that the IJ document pixel identification result is once stored in the RAM 206.

The above processing method by Expression (7) shows the determination example for each pixel by referring to one pixel only. Next, Expression (8) is used to show another processing method of making the IJ document determination for each pixel by referring to the periphery of the pixel two-dimensionally in some degree.

In a case where ΣΣ P(i)×FJ(i)>K7, IJ(i)=1, that is, the pixel is determined as the IJ document pixel.

In a case where ΣΣ P(i)×FJ(i)≦K7, IJ(i)=0, that is, the pixel is determined as other than the IJ document pixel.

### Expression (8)

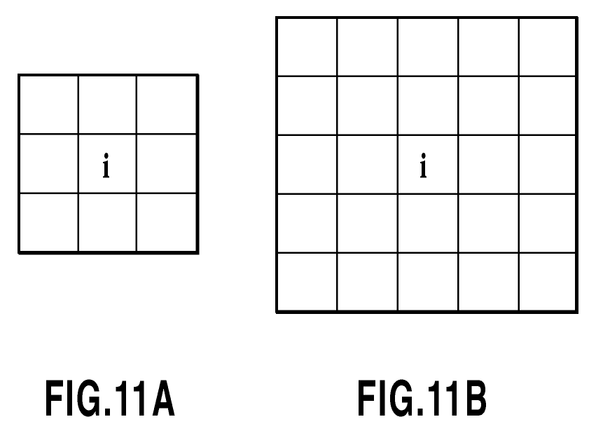

For example, as shown in each of FIGS. 11A and 11B, a sum of P(i)×FJ(i) in positions of 8 pixels or 24 pixels neighboring around the attention pixel position is found. Then, threshold value processing is executed to the obtained value by using constant K7. By thus considering also the periphery of the attention pixel, the stable determination result which is not affected by noises and has no variation for each pixel can be obtained. This processing is effective upon correcting an image region of a portion added by a fluorescent pen in a part of a page to be described later. In a flow chart in FIG. 1, when each process of S100 in regard to identification of presence/absence of the paper fiber, S101 in regard to print pixel identification and S102 in regard to IJ document pixel identification is completed to all the pixels in one page, it is determined at S104 whether or not the document is an ink jet document requiring a correction.

Next, the process at S104 will be explained.

Since it is usually general that the printing method is the same in an entire region of the document, the processing in a case where it is determined for each page whether or not the read document is the ink jet document requiring the correction wilt be explained.

In this case, first, ink jet document pixels included in one page of a document obtained by each process of S100 and S102 which are once stored in the RAM 206 are counted to find a ratio to a sum of the entire print pixels. In addition, whether or not the document is the ink jet document requiring the correction is determined based upon whether or not a relation of the found ratio and threshold value K6 meets Expression (9).

In a case a ratio of a sum of pixels in a case IJ(i)=1 to a sum of pixels in a case P(i)=1>K6, it is determined that the document is the IJ document, and

in a case a ratio of a sum of pixels in a case IJ(i)=1 to a sum of pixels in a case P(i)=1≦K6, it is determined that the document is not the IJ document.

### Expression (9)

Here, K6 is a constant.

In a case where it is determined in the process at S104 that the document is not the ink jet document, the branch at S104 is “No” where the process goes to S107 of image signal output process not via S105 of image correction process. That is, the image signals of one page which are separated into each color of R, G and B and which are stored in the RAM 206 are outputted to the image region separating unit 211 or the external IF unit 204 as output of the IJ document identifying/image correcting unit 210 as they are.

On the other hand, in a case where it is determined in the process at S104 that the document is the ink jet document, the branch at S104 is “Yes”, and at S105 of image correction, the process of the image correction is executed.

Here, the processing method in a case where the document is printed on a plain paper by an ink jet printing method is shown. In this case, the processing of emphasizing color saturation is executed to values of P(i), G(i) and B(i) read by a sensor. This is because it is predicted that in the image copied or printed on the plain paper by the ink jet printing method, the color saturation is degraded as compared to that of the original data.

A method of adjusting the color saturation is widely well known and here, a coordinate system of L*, a* and b* which is a uniform color space is used. Conversion from a coordinate system of R/G/B into a coordinate system of L*, a* and b* is made in such a manner that, as well known, the coordinate system of R/G/B is converted into coordinates of XYZ and thereafter, the coordinates of XYZ are converted into the coordinate system of L*, a* and b*. Each value of a* and b* obtained herein is multiplied by α (>1) using Expression (10), wherein

a*′=α×a* b*′=α×b* Expression (10)

This method generates a*′ and b*′ by correcting the color saturation degradation occurring in the ink jet document for the emphasizing.

Further, since it is predicted that the bleeding is occurring to the image on the plain paper printed by the ink jet printing method, a space filter is used to a L* signal converted into L*, a* and b* as the uniform color space to restore the bleeding. The space filter for the restoration is a so-called Laplacian filter β, and for example, there is provided L*′ in which the bleeding is restored according to Expression (11) using a value of L* in a region of neighboring pixels of 3*3.

L*′(i)=ΣΣβL*(i) Expression (11)

As described above, the values of a*′, b*′ and L*′ in which the color saturation and the bleeding are corrected are converted into XYZ coordinates to obtain X′, Y′ and Z′. Further, the XYZ coordinates are converted into R/G/B coordinates to generate R′(i), G′(i) and B′(i) in which the color saturation and the bleeding are corrected.

This processing is executed in all the pixels inside a page.

It should be noted that the color saturation emphasis and the bleeding correction are not limited to the coordinate system of L*, a* and b*, and other known technologies can be applied without mentioning

When S105 of image correction processing is completed over all the pixels in one page, the branch at S106 is “Yes”, and the process goes to S107 of image signal output processing. That is, the image signal which is separated into each color separation of R/G/B and which is corrected in image is outputted to the image region separating unit 211 or the external IF unit 204 as output of the IJ document identifying/image correcting unit 210.

In a case of copying the ink jet document according to the above processing, to the image signal in which the correction processing of the bleeding or the color saturation is executed in the IJ document identifying/image correcting unit 210, various types of image processing at a later stage of the subsequent color image processing device 203 already described are executed. In consequence, in the image output device 202, reproduction of the image with a high-grade image quality in which the color saturation is high and the bleeding is corrected is possible.

On the other hand, in a case where the ink jet document is transmitted as a facsimile or as an electronic image file to a personal computer, the processing necessary for each case is executed in the external IF unit 204, and thereafter, the document with a high-grade image quality in which the color saturation is high and the bleeding is corrected is transmitted.

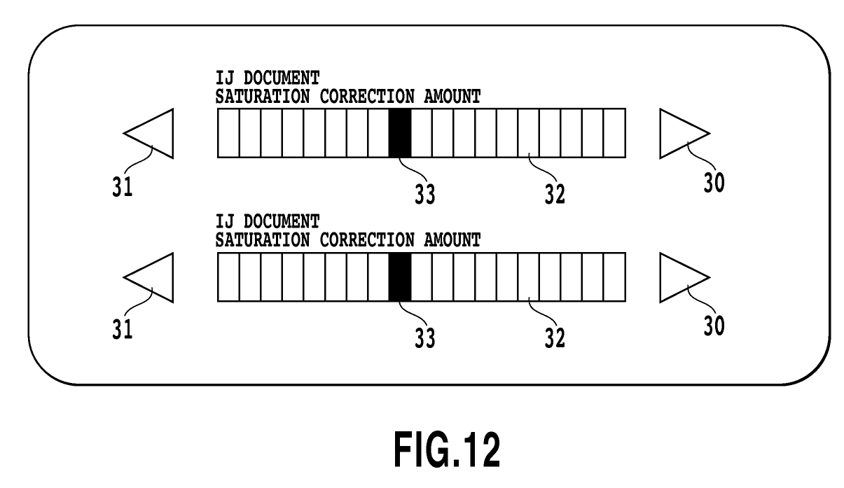

It should be noted that FIG. 12 is one screen of the operation panel 208 on which an operator sets parameters α and β in the above processing for the image correction. The operation panel 208 is provided with touch panel keys 30 and 31 for adjusting the correction amount in each of color saturation and bleeding, and bar display sections 32 including a current level display section 33. The touch panel key 30 is used for reducing the correction amount, and the touch panel key 31 is used for increasing the correction amount. When the touch panel keys 30 and 31 respectively are pressed down, the current level display unit 33 moves right or left on the bar display sections 32 to change the correction amount. That is, for example, in regard Lo the color saturation correction amount, the color saturation correction amount is reduced by an amount corresponding to the extent that the touch panel key 31 is pressed down, and a value of a is closer to 1. In regard to the bleeding correction amount, the bleeding correction amount is increased by an amount corresponding to the extent that the touch panel key 30 is pressed down, and the space filter β is supposed to set the emphasis degree in a higher region section more strongly. In this way, an operator can arbitrarily adjust the degree of the correction while visually confirming the image.

As a different processing method at S105 of the image correction, there is shown the processing method in a case where in a case it is found out that the document is printed on a plain paper by an ink jet printing method, the processing of increasing the density is executed to values of R(i), G(i) and B(i) read by a sensor. This is because it is predicted that in the image copied or printed on the plain paper by the ink jet printing method, the density is lowered as compared to that of the original data. A method of adjusting the density is widely well known and here, a coordinate system of L*, a* and b* which is a uniform color space is used. Conversion from a coordinate system of R/G/B into a coordinate system of L*, a* and b* is made in such a manner that, as well known, the coordinate system of R/C/B is converted into coordinates of XYZ and thereafter, the coordinates of XYZ are converted into the coordinate system of L*, a* and b*. A value of L* obtained herein is multiplied by a (<1) using Expression (12), wherein

L*′=α×L* Expression (12)

This method generates L*′ in which the density reduction occurring in the ink jet document is corrected. It should be noted that the method of restoring the bleeding is the same even in a case of this processing method. Accordingly, a detailed explanation thereof is omitted, but the filter processing shown in Expression (11) is executed to L*′ corrected in Expression (12).

As described above, the value of L*′ in which the density and the bleeding are corrected is converted into XYZ coordinates to obtain X′, Y′ and Z′. Further, the XYZ coordinates are converted into R/G/B coordinates to generate R′(i), G′(i) and B′(i) in which the density and the bleeding are corrected. Since herein, the correction processing is executed only to L* converted into the uniform color space, the number of the calculation processes is small and the correction processing is suitable for the high-speed processing. In addition, in a monochrome system, the correction processing of each of Expression (11) and Expression (12) can be, as shown in Expression (13), executed at the same time directly to the brightness signal A(i).

A′(i)=α×ΣΣβ×A(i) Expression (13)

It should be noted that in regard to the content of the above correction processing, either of color saturation, bleeding and density or a combination thereof may be adopted as needed.

### Second Embodiment

In the first embodiment, the determination of the inkjet document is made all together over the entire page region of the document. Therefore, in a case where the bleeding or the color saturation degradation occurs in a part of the document, such as the document having a portion added on the electronic photo document by the fluorescent pen, a partial image correction to the added portion can not be made.

Therefore, a second embodiment shows a method in which the image correction can be made to the document having a portion partially added by the fluorescent pen.

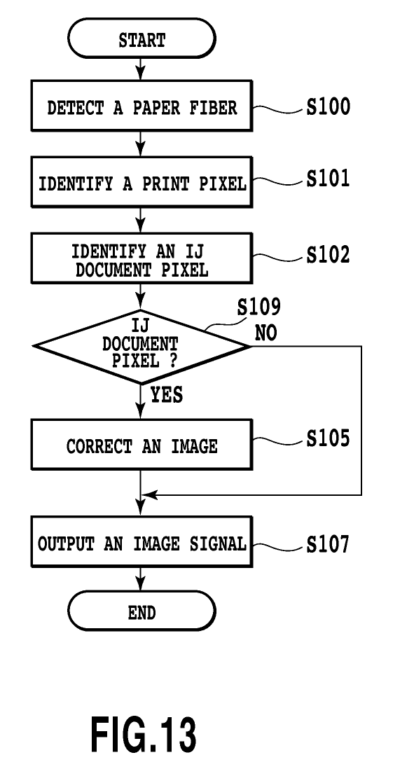

A flow chart in FIG. 13 shows a flow of the processing at an IJ document identifying/image correcting unit 210 according to the second embodiment. It should be noted that processes in the second embodiment identical to those in FIG. 1 according to the first embodiment are referred to as identical numbers and the explanation is omitted.

The second embodiment differs in the following point from the first embodiment. The point is, the determination is sequentially made for each pixel to image signals which are corrected in shading and raster-inputted, and in the pixel which is determined as the ink jet document requiring the correction, the image correction continues to be made per pixel unit.

First, at S100 in FIG. 13, the fiber determination FJ(i) is corrected in regard to presence/absence of the diffuse reflective image of the paper fiber at the attention pixel position with the pattern shown in FIG. 8A or FIG. 8B in the same way as in a case of the first embodiment.

In addition, also at S101 of print pixel identification, the print pixel determination result P(i) is corrected at the attention pixel position with the pattern shown in FIG. 10A or FIG. 10B in the same way as in a case of the first embodiment.

Further, at S102 of IJ document pixel identification, the determination processing is executed according to Expression (8) in detail described in the first embodiment, thereby preventing the IJ document pixel identification result from varying for each pixel.

Here, in a case where the determination result by the IJ document pixel identification has a relation of “IJ(i)=1”, the branch at S109 is “Yes” where S105 of image correction process is executed. The corrected image signal which is separated into each color of R, G and B is outputted to the image region separating unit 211 or the external IF unit 204 as output of the IJ document identifying/image correcting unit 210 at S107.

On the other hand, in a case where the determination result by the IJ document pixel identification has a relation of “IJ(i)=0”, the branch at S109 is “No” where the process goes to S107 of image signal output. The image signal which is separated into each color of R, G and B is outputted as it is without the correction to the image region separating unit 211 or the external IF unit 201 as output of the IJ document identifying/image correcting unit 210.

The above processing is repeated in regard to all the pixels in the document per pixel unit.

### Third Embodiment

In the above second embodiment, each process in the IJ document identifying/image correcting unit 210 is executed based upon the program stored in the RAM 205 by the CPU 207 and is the process by software.

In the third embodiment, the construction of sequentially processing the image signals obtained by raster-scanning the document for each pixel is realized with the pipeline processing by hardware.

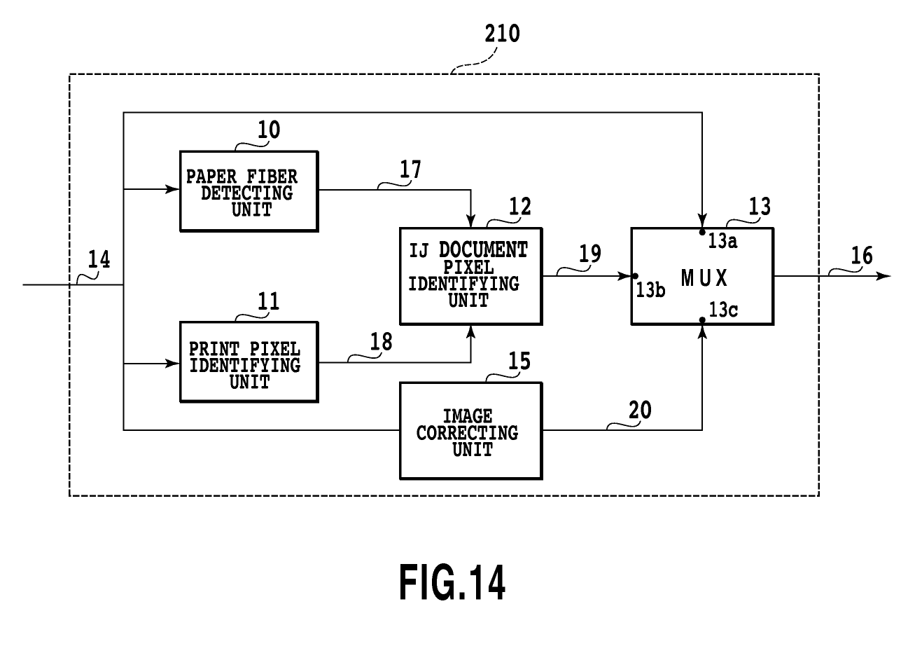

FIG. 14 is a block diagram showing an outline in a case where the IJ document identifying/image correcting unit 210 is constructed of hardware.

The image signal 14 which is corrected at the shading correcting unit 209 and which is separated into each color of R/G/B is inputted to a paper fiber detecting unit 10, a print pixel identifying unit 11, an image correcting unit 15 and a multiplexer (MUX) 13.

In the paper fiber detecting unit 10, a brightness signal A(i) is generated from the image signal 14 separated into each color of R/G/B. The calculation already explained at S100 is realized by a logic circuit and a paper fiber detecting result signal 17 is inputted to an IJ document pixel identifying unit 12.

In the print pixel identifying unit 11, the brightness signal A(i) is generated from the image signal 14 separated into each color of R/G/B. The calculation already explained at S101 is realized by a logic circuit and a print pixel identification result signal 18 is inputted to the IJ document pixel identifying unit 12.

In the IJ document pixel identifying unit 12, the calculation already explained at S102 is realized by a logic circuit and an IJ document pixel identification result signal 19 is outputted to a selection signal input terminal 13b of the multiplexer (MUX) 13.

In the image correcting unit 15, the image signal 14 separated into each color of R/G/B is converted into the uniform color space of L*, a* and b*. The calculation already explained at S105 is realized by a logic circuit and thereby, the image signal in which the color saturation is emphasized and the bleeding is corrected is outputted as an image signal 20 of R/G/B to an input terminal. 13c of the multiplexer (MUX) 13.

The image signal 14 before the correction which is separated into each color of R/G/B is inputted to an input terminal 13a of the multiplexer (MUX) 13. In the multiplexer (MUX) 13, in a case where it is determined that the document is the ink jet document pixel based upon the IJ document pixel identification result signal 19, the image signal 20 of R/G/B in which the color saturation is emphasized and the bleeding is corrected is selected. The image signal 20 of P/G/B is outputted as an output image signal 16 of the IJ document identifying/image correcting unit 210 to the image region separating unit 211 and the external IF unit 204.

The logic circuit for carrying out the calculation of each above unit is realized as the pipeline processing in synchronization with an image clock (not shown). The third embodiment is suitable for a copying machine requiring high speed performance since it is more suitable for high speed processing as compared to the first embodiment or the second embodiment.

### Other Embodiment

The scope of the aforementioned embodiments includes also a processing method in which the program realizing the :function of the aforementioned embodiments is stored in the computer readable printing medium and the program stored in the printing medium is read out as a code, which will be executed by the computer. Further, not only the printing medium in which the aforementioned program is stored, but also the program itself is included in the aforementioned embodiments.

Such a printing medium includes, for example, a floppy (registered trademark) disc, a hard disc, an optical disc, an optical magnetic disc, a CD-OM, a magnetic tape, an involatile memory card, and a ROM.

In addition, the scope of the aforementioned embodiments is not limited to the processing executed by the single program stored in the aforementioned printing medium, and includes also a processing method in which the program operates on an OS in cooperation with other software and a function of an expansion board to perform the operations of the aforementioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-174713, filed Jul. 3, 2008, which is hereby incorporated by reference herein in its entirety.

What is claimed is:

1. An image processing device comprising:
a paper fiber detecting unit configured to detect a paper fiber for each pixel by an image signal obtained by reading a document;
a print pixel identifying unit configured to identify whether or not pixels are print pixels for each pixel by the image signal;
a document pixel identifying unit configured to identify whether or not the pixel is a pixel requiring a correction based upon the detection result by the paper fiber detecting unit and the identification result by the print pixel identifying unit; and
an image correcting unit configured to correct the image signal in a case where it is determined that the pixel is the document pixel requiring the correction by the document pixel identifying unit.

2. An image processing device comprising:
a paper fiber detecting unit configured to detect a paper fiber for each pixel by an image signal obtained by reading a document;
a print pixel identifying unit configured to identify whether or not pixels are print pixels for each pixel by the image signal;
a document pixel identifying unit configured to identify whether or not the pixel is a pixel requiring a correction based upon the detection result by the paper fiber detecting unit and the identification result by the print pixel identifying unit;
a document identifying unit configured to, after the identifications on all the pixels in the document by the document pixel identifying unit are completed, determine whether or not the document is a document requiring a correction, for each page based upon the identification result; and
an image correcting unit configured to correct the image signal in a case where it is determined that the document is the document requiring the correction by the document identifying unit.

3. An image processing device according to claim 1, wherein:
the document pixel identifying unit determines that the pixel in which the paper pixel is detected by the paper fiber detecting unit and which is identified as the print pixel by the print pixel identifying unit is the pixel requiring the correction.

4. An image processing device according to claim 2, wherein:
the document pixel identifying unit determines that the pixel
in which the paper pixel is detected by the paper fiber detecting unit and which is identified as the print pixel by the print pixel identifying unit is the pixel requiring the correction.

5. An image processing device according to claim 1, wherein:
the image correcting unit corrects either of color saturation, bleeding and density or a combination thereof.

6. An image processing device according to claim 2, wherein:
the image correcting unit corrects either of color saturation, bleeding and density or a combination thereof.

7. An image processing device according to claim 1, wherein:
the paper fiber detecting unit detects the paper fiber based upon a brightness signal obtained from the image signal.

8. An image processing device according to claim 2, wherein: the paper fiber detecting unit detects the paper fiber based upon a brightness
signal obtained from the image signal.

9. An image processing method, the method comprising the steps of:
detecting a paper fiber for each pixel by an image signal obtained by reading a document;
identifying whether or not pixels are print pixels for each pixel by the image signal;
identifying whether or not the pixel is a pixel requiring a correction based upon the detection result by the paper fiber detecting step and the identification result by the print pixel identifying step; and
correcting the image signal in a case where it is determined that the pixel is the document pixel requiring the correction by the step of identifying whether or not the pixel is the pixel requiring the correction.

10. An image processing method, the method comprising the steps of:
detecting a paper fiber for each pixel by an image signal obtained by reading a document;
identifying whether or not pixels are print pixels for each pixel by the image signal;
identifying whether or not the pixel is a pixel requiring a correction based upon the detection result by the paper fiber detecting step and the identification result by the print pixel identifying step;
after the identifications on all the pixels in the document by the step of identifying whether or not the pixel is the pixel requiring the correction are completed, determining whether or not the document is a document requiring a correction, for each page based upon the identification result; and
correcting the image signal in a case where it is determined that the document is the document requiring the correction by the step of identifying whether or not the document is the document requiring the correction.

11. A program on a computer readable medium for performing
an image processing method, the method comprising the steps of:
detecting a paper fiber for each pixel by an image signal obtained by reading a document;
identifying whether or not pixels are print pixels for each pixel by the image signal;
identifying whether or not the pixel is a pixel requiring a correction based upon the detection result by the paper fiber detecting step and the identification result by the print pixel identifying step; and
correcting the image signal in a case where it is determined that the pixel is the document pixel requiring the correction by the step of identifying whether or not the pixel is the pixel requiring the correction.
